(19) United States
(12) Patent Application Publication
(10) Pub. No.: US 2016/0305379 A1
(43) Pub. Date: Oct. 20, 2016

(54) Combination Exhaust and Supply Duct

(71) Applicants: Behrooz Bruce Entezam, Santa Ana, CA (US); Sergey V. Levinson, San Diego, CA (US)

(72) Inventors: Behrooz Bruce Entezam, Santa Ana, CA (US); Sergey V. Levinson, San Diego, CA (US)

(21) Appl. No.: 15/131,862

(22) Filed: Apr. 18, 2016

Related U.S. Application Data
(60) Provisional application No. 62/148,384, filed on Apr. 16, 2015.
(60) Provisional application No. 62/190,890, filed on Jul. 10, 2015.

(51) Int. Cl. F02M 35/10; F02M 35/024; F02M 26/20

(52) U.S. Cl. CPC F02M 35/10288; F02M 26/20; F02M 35/10222; F02M 35/02416

(57) ABSTRACT

A combination exhaust and supply duct is an air duct system which combines an inlet and an outlet for a ventilation system into a single dual-purpose duct. The dual-purpose duct allows for better flexibility in positioning for the atmospheric interface of the dual-purpose duct in accordance to minimum distance regulations between other adjoining exhaust and supply ducts. The combination exhaust and supply duct additionally includes: an air-supply duct to allow for the flow of air into the structure; an exhaust duct to remove air from the structure; a diverting duct to divert the flow of air from the dual-purpose duct to the air-supply duct or from the exhaust duct to the dual-purpose duct; an inline duct fan to create a pressure difference to force air through the dual-purpose duct to the air-supply duct; and a control device to control the inline duct fan and other electrical components.

The current application claims a priority to the U.S. Provisional Patent application Ser. No. 62/148,384 filed on Apr. 16, 2015 and a priority to the U.S. Provisional Patent application Ser. No. 62/190,890 filed on Jul. 10, 2015.

### FIELD OF THE INVENTION

The present invention relates generally to an air duct apparatus. More specifically, the present invention relates to a combination air duct configuration in order to utilize a single duct to intake air from and exhaust air to the atmosphere.

### BACKGROUND OF THE INVENTION

Typically, ventilation systems implement a duct for exhausting air from and a duct for supplying air to a structure, such as a building or apartment, to circulate fresh air throughout the structure. Regulations require exhaust ducts and air-supply ducts to be positioned at least at a minimum distance away from each other such that the output from an exhaust duct is not immediately input into the air-supply duct. These regulations restrict the placement of duct inlets and outlets between residences and commercial buildings.

The present invention seeks to increase the flexibility for placing duct vents for habitable structures, such as apartment buildings, high density housing, and commercial buildings. The present invention implements a dual-purpose duct to provide a supply of fresh air to a structure, as well as, to exhaust existing air from the room or building. The fresh air is able to be diverted through an air-supply duct in order to provide fresh air throughout the structure. Through use of the dual-purpose duct, the present invention is able to exhaust stale or hazardous air from the structure.

### BRIEF DESCRIPTION OF THE DRAWINGS

FIG. 1 is a schematic view for the preferred embodiment of the present invention, wherein the inline duct fan is mounted within the air-supply duct.

FIG. 2 is a schematic view for an embodiment of the present invention, wherein the inline duct fan is mounted within the dual-purpose duct and the control device is toggled to a first state.

FIG. 3 is a schematic view for an embodiment of the present invention, wherein the inline duct fan is mounted within the dual-purpose duct, the control device is toggled to a second state and the diverting duct comprises a three-way valve.

FIG. 4 is a schematic view of the present invention, wherein the present invention comprises an air-supply bypass duct and the control device is toggled to the first state.

FIG. 5 is a schematic view of the present invention, wherein the present invention comprises an air-supply bypass duct and the control device is toggled to the second state.

FIG. 6 is a schematic view of the present invention, wherein the inline duct fan and the exhaust fan are mounted within the diverting duct.

### DETAIL DESCRIPTIONS OF THE INVENTION

All illustrations of the drawings are for the purpose of describing selected versions of the present invention and are not intended to limit the scope of the present invention.

The present invention is a combination exhaust and supply duct in order to provide a duct system which increases the flexibility of placing the outlet for the duct system with respect to atmospheric outlets for other adjoining duct systems. The present invention is mounted within a structure in order to transfer air into and out from the structure to create a habitable space.

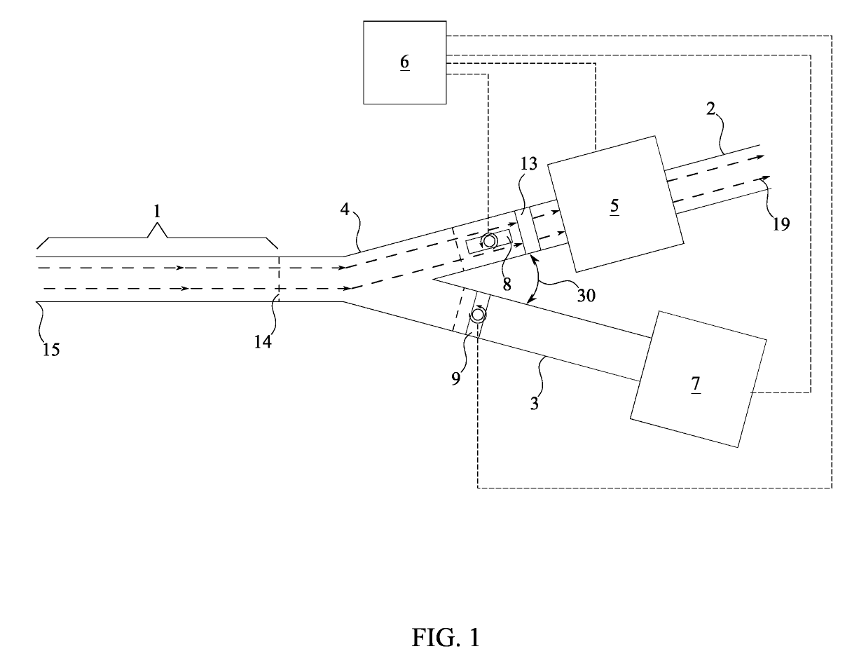

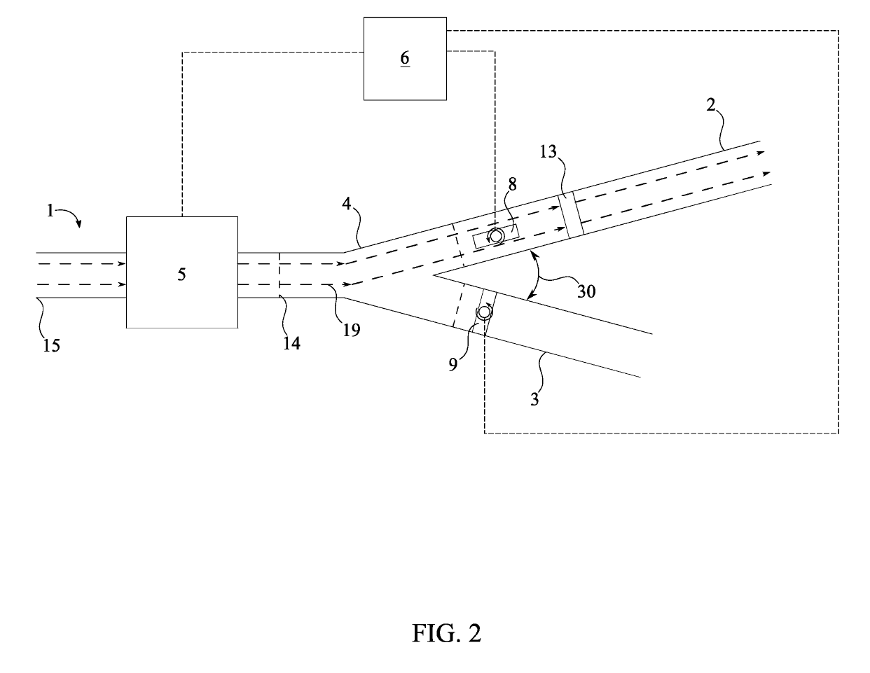

In accordance to FIG. 1 and FIG. 2, the present invention comprises a dual-purpose duct 1, an air-supply duct 2, an exhaust duct 3, a diverting duct 4, an inline duct fan 5, and a control device 6. The dual-purpose duct 1 allows for the flow of air into and from the present invention and the atmosphere. The air-supply duct 2 allows for atmospheric air to be supplied to the structure for ventilation purposes. The exhaust duct 3 allows for the removal of air from the structure into the atmosphere. The diverting duct 4 allows for the flow of air to be directed within the system. The diverting duct 4 also provides a junction between the dual-purpose duct 1, the air-supply duct 2, and the exhaust duct 3. The dual-purpose duct 1 is adjacently connected to the diverting duct 4. The air-supply duct 2 is adjacently connected to the diverting duct 4, opposite to the dual-purpose duct 1. This configuration allows an inlet 14 of the dual-purpose duct 1 and the air-supply duct 2 to be in fluid communication with each other, such that air is able to flow efficiently between the dual-purpose duct 1 and the air-supply duct 2. The exhaust duct 3 is adjacently connected to the diverting duct 4, opposite to the dual-purpose duct 1, such that air is able to flow efficiently between the dual-purpose duct 1 and the exhaust duct 3. The exhaust duct 3 is preferred to be positioned at an acute angle 30, between 20° and 90°, to the air-supply duct 2 in order to limit friction loss between the dual-purpose duct 1 and the air-supply duct 2 and between the dual-purpose duct 1 and the exhaust duct 3. This configuration allows an outlet 15 and the exhaust duct 3 to be in fluid communication with each other, through the diverting duct 4, such that air is able to flow efficiently between the dual-purpose duct 1 and the exhaust duct 3. The inline duct fan 5 is in fluid communication with the outlet 15 through the dual-purpose duct 1. This allows the inline duct fan 5 to provide a pressure difference within the present invention to force the flow of air from the atmosphere into the structure which the present invention is mounted. The inline duct fan 5 is electronically coupled with the control device 6 such that the control device 6 manipulates duration, frequency and speed which the inline duct fan 5 operates.

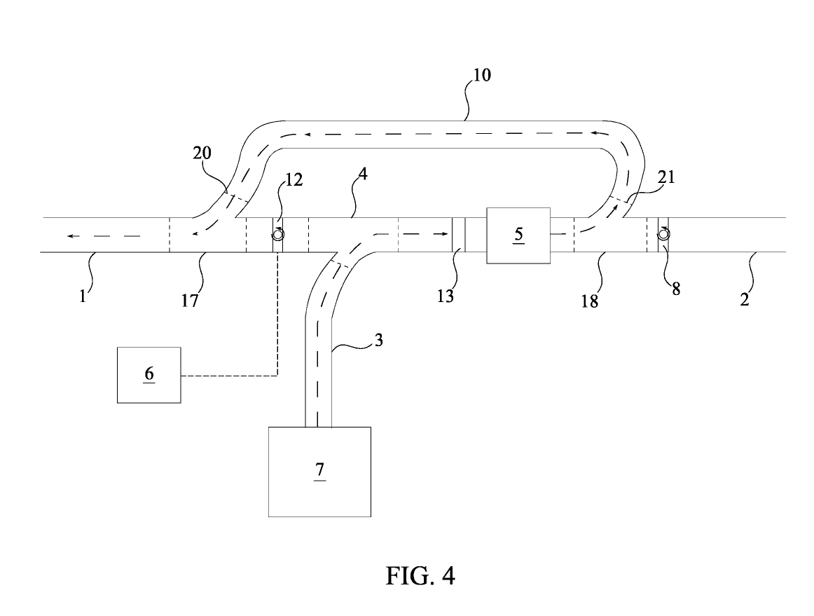

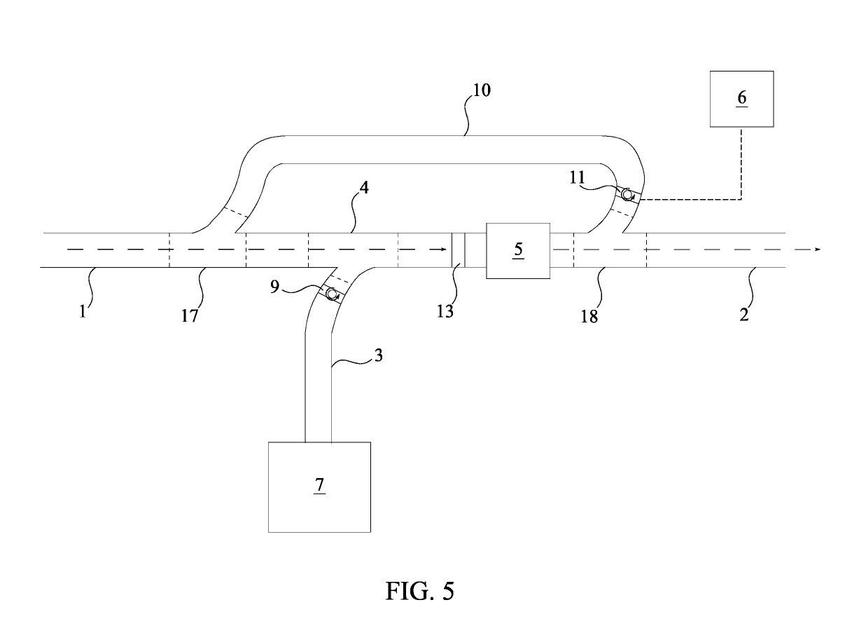

In one embodiment of the present invention, the present invention comprises an exhaust fan 7, as detailed in FIG. 1, FIG. 4, and FIG. 5. The exhaust fan 7 creates a pressure difference in order to transfer air from the structure to the atmosphere. The exhaust fan 7 is in fluid communication with the outlet 15 such that air is able to be forced into the dual-purpose duct 1 and subsequently through the outlet 15 into the atmosphere. The exhaust fan 7 is electronically coupled with the control device 6, such that the control device 6 manipulates the duration, frequency, and speed which the exhaust fan 7 operates. In one configuration of this embodiment, the exhaust fan 7 is mounted within the exhaust duct 3 in order to transfer air through the exhaust duct 3 from the ambient air within the structure.

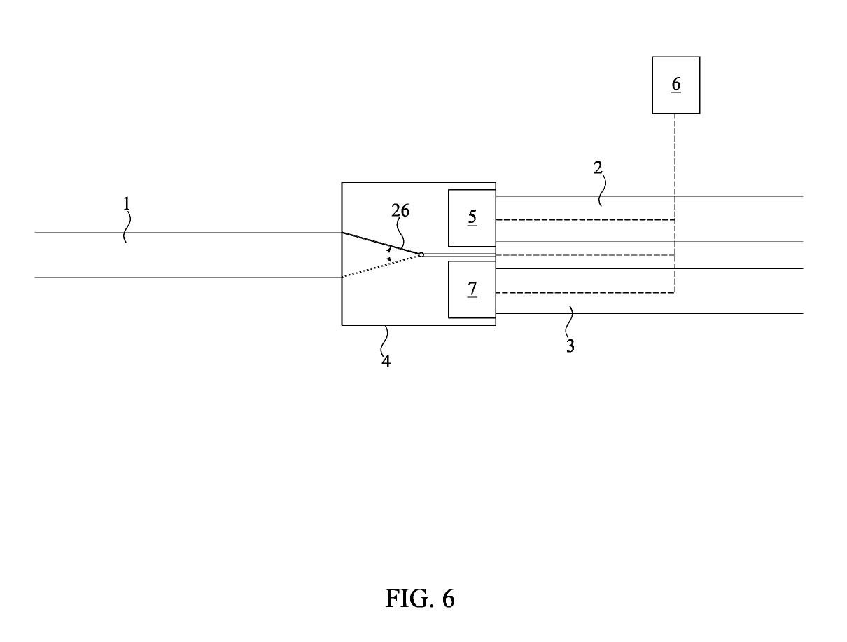

In another configuration of this embodiment shown in FIG. 6, the present invention comprises a diverting mechanism 26. The diverting mechanism 26 allows the flow of air through diverting duct 4 to be directed into the air-supply duct 2 or out from the exhaust duct 3. The exhaust fan 7 is mounted within the diverting duct 4. The exhaust fan is positioned adjacent to the exhaust duct 3. The inline duct fan 5 is mounted within the diverting duct 4. The inline duct fan 5 is positioned adjacent to the air-supply duct 2. The diverting mechanism 26 is operatively integrated within the diverting duct 4, wherein the diverting mechanism 26 is used to direct the flow of air through either the air-supply duct 2 or the exhaust duct 3. The diverting mechanism 26 is electronically coupled with the control device 6, such that the control device 6 is able to signal the diverting mechanism 26 to be actuated in accordance to the desired direction for the flow of air.

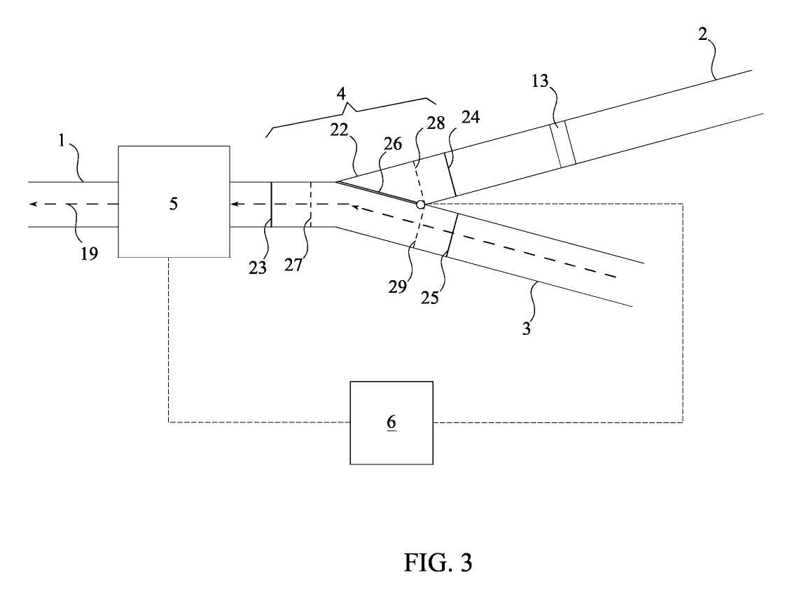

In another embodiment of the present invention, the inline duct fan 5 is mounted within the air-supply duct 2 in order to provide pressure difference to force air into the structure which the present invention is mounted within, as shown in FIG. 2 and FIG. 3. A fluid propagation direction 19 of the inline duct fan 5 is oriented away from the inlet 14 of the dual-purpose duct 1 in order for air to flow into the structure through the air-supply duct 2. In an alternate embodiment of the present invention, the inline duct fan 5 is mounted within the dual-purpose duct 1, such that the inline duct fan 5 is able to create a pressure difference in two directions, into and out from the structure which the present invention is mounted within. In accordance to this embodiment, the inline duct fan 5 is reversible, such that the control device 6 toggles the inline duct fan 5 between two states: a first state to exhaust air from the structure, detailed in FIG. 3 and FIG. 4, and a second state for supplying air to the structure, shown in FIG. 1, FIG. 2, and FIG. 5. When the control device 6 is toggled in the first state, the fluid propagation direction 19 of the inline duct 5 is oriented towards the outlet 15 in order to exhaust air from the structure into the atmosphere. When the control device 6 is toggled in the second state, the fluid propagation direction 19 in oriented towards the inlet 14 of the dual-purpose duct 1 in order to force air into the structure through the air-supply duct 2. The control device 6 allows for an intermediate interval of time to elapse between being toggled from the first state to the second state, such that exhausted air is not immediately drawn through the air-supply duct 2 or drafts into the exhaust duct 3.

In accordance to the preferred embodiment of the present invention, the present invention comprises an inlet damper 8, as shown in FIG. 1, FIG. 2, and FIG. 4. The inlet damper 8 is a valve or plate which restricts the flow of air to and allows the flow of air through the air-supply duct 2. The inlet damper 8 is electronically coupled with the control device 6 such that the inlet damper 8 receives control signals to be actuated in order to manipulate the fluid flow to and from the air-supply duct 2. The inlet damper 8 is operatively integrated into the air-supply duct 2, wherein the inlet damper 8 is used to hermetically seal the air-supply duct 2 or is used to allow fluid flow through the air-supply duct 2. The inlet damper 8 is positioned adjacent to the diverting duct 4 in order to limit the friction loss of the flow of air through the present invention when the inlet damper 8 hermetically seals the air-supply duct 2. When the control device 6 is toggled to the first state, the inlet damper 8 hermetically seals the air-supply duct 2, such that the exhaust flow is channeled through the present invention without significant friction loss as the flow of air passes the inlet damper 8 through the diverting duct 4. When the control device 6 is toggled to the second state, the inlet damper 8 is positioned to provide an optimally unrestricted cross-section for the flow of air to pass through the air-supply duct 2.

The present invention further comprises an exhaust damper 9, in accordance to FIG. 1, FIG. 2, and FIG. 5. The exhaust damper 9 is a valve or plate which restricts the flow of air to and allows the flow of air through the exhaust duct 3. The exhaust damper 9 is electronically coupled with the control device 6, such that the exhaust damper 9 receives control signals to be actuated in order to manipulate the fluid flow to and from the exhaust duct 3. The exhaust damper 9 is operatively integrated into the exhaust duct 3, wherein the exhaust damper 9 is used to hermetically seal the exhaust duct 3 or is used to allow fluid flow through the exhaust duct 3. The exhaust damper 9 is positioned adjacent to the diverting duct 4 in order to limit the friction loss of the flow of air through the present invention when the exhaust damper 9 hermetically seals the exhaust duct 3. When the control device 6 is toggled to the first state, the exhaust damper 9 is positioned to provide an optimally unrestricted cross-section for the flow of air to pass through the exhaust duct 3. When the control device 6 is toggled to the second state, the exhaust damper 9 hermetically seals the exhaust duct 3, such that the flow of air is channeled through the present invention without significant friction loss as the flow of air passes the exhaust damper 9 and through the air-supply duct 2.

The control device 6 prevents the actuation of the inline duct fan 5 when the inlet damper 8 is positioned to hermetically seal the air-supply duct 2, in order to prevent a vacuum from forming or air pressure from increasing between the inlet damper 8 and the inline duct fan 5. Similarly, the control device 6 prevents the actuation the exhaust fan 7 when the exhaust damper 9 is positioned to hermetically seal the exhaust duct 3, in order to prevent a vacuum from forming or air pressure from increasing between the exhaust damper 9 and the exhaust fan 7.

In another embodiment of the present invention, the diverting duct 4 comprises a three-way valve 22, a convergent duct 23, a first divergent duct 24, and a second divergent duct 25, as depicted in FIG. 3. The three-way valve 22 controls the rate of fluid flow between the dual-purpose duct 1 and either the air-supply duct 2 or the exhaust duct 3. The three-way valve 22 comprises a diverting mechanism 26, a valve inlet 27, a first valve outlet 28, and a second valve outlet 29. The diverting mechanism 26 is integrated between the valve inlet 27, the first valve outlet 28, and the second valve outlet 29 in order to change the direction of fluid flow between the dual-purpose duct 1 and the air-supply duct 2 or the exhaust duct 3. The convergent duct 23 is hermetically coupled with the dual-purpose duct 1. The first divergent duct 24 is hermetically coupled with the air-supply duct 2. The second divergent duct 25 is hermetically coupled with the exhaust duct 3. The convergent duct 23 is hermetically coupled to the valve inlet 27. The first divergent duct 24 is coupled with the first valve outlet 28. The second divergent duct 25 is hermetically coupled with the second valve outlet 29. This configuration allows for air to flow either between the dual-purpose duct 1 and the air-supply duct 2 or between the dual-purpose duct 1 and the exhaust duct 3 as the diverting mechanism 26 is positioned. The diverting mechanism 26 is electronically coupled with the control device 6 such that the diverting mechanism 26 is able to be toggled in accordance to the direction for the flow of air between the first state and the second state of the control device 6.

In accordance to another embodiment of the present invention, the present invention comprises an air-supply bypass duct 10, as shown in FIG. 4 and FIG. 5. The air-supply bypass duct 10 allows the exhaust flow to bypass the air-supply duct 2 by providing a channel which reduces friction loss of the flow of air from the exhaust duct 3 to the outlet 15 in comparison to a direct channel to the outlet 15. Friction loss is reduced by providing a more gradual curvature in the bent joints throughout the path of the flow of air between the exhaust duct 3 and the outlet 15 than a direct channel would otherwise have. The air-supply bypass duct 10 comprises a first end 20 and a second end 21. The present invention further comprises a first bypass wye duct 17 and a second bypass wye duct 18. The first end 20 is in fluid communication with the dual-purpose duct 1 through the first bypass wye duct 17. The first bypass wye duct 17 is mounted within the dual-purpose duct 1, such that the flow of air is transferred freely through the dual-purpose duct 1 from the outlet 15 and into the diverting duct 4 or from the air-supply bypass duct 10 to the outlet 15. The first end 20 is hermetically coupled to the first bypass wye duct 17, such that fluid is able to flow freely from the air-supply bypass duct 10 into the dual-purpose duct 1. Likewise, the second end 21 is in fluid communication with the air-supply duct 2, through the second bypass wye duct 18. The second end 21 is hermetically coupled to the second bypass wye duct 18. The second bypass wye duct 18 is mounted within the air-supply duct 2, such that the flow of air is able to flow freely through the air-supply duct 2 or to the air-supply bypass duct 10 from the air-supply duct 2.

In further accordance to this embodiment, the present invention comprises an inlet damper 8. The inlet damper 8 is operatively integrated into the air-supply duct 2, as previously mentioned, wherein the inlet damper 8 is used to hermetically seal the air-supply duct 2 or is used to allow air to flow through the air-supply duct 2; however, in this embodiment, the inlet damper 8 is positioned adjacent to the second bypass wye duct 18, opposite to the diverting duct 4, in accordance to FIG. 4. When the control device 6 is toggled to the first state, the inlet damper 8 hermetically seals the air-supply duct 2 such that the exhaust flow is channeled through the air-supply bypass duct 10 without significant friction loss as the flow of air passes the inlet damper 8 from the exhaust duct 3 into the air-supply bypass duct 10. When the control device 6 is toggled to the second state, the inlet damper 8 is positioned to provide an optimally unrestricted cross-section for the flow of air to pass through the air-supply duct 2.

The present invention further comprises an exhaust bypass damper 11, show in FIG. 5 and an inlet bypass damper 12, shown in FIG. 4. The exhaust bypass damper 11 and the inlet bypass damper 12 control the flow of air through the present invention similar to the exhaust damper 9 and the inlet damper 8. The exhaust damper 9 is operatively integrated into the air-supply bypass duct 10, wherein the exhaust bypass damper 11 is used to hermetically seal the air-supply bypass duct 10 or is used to allow air to flow through the air-supply bypass duct 10. The exhaust bypass damper 11 is positioned adjacent to the second bypass wye duct 18 in order to prevent air from flowing into the air-supply bypass duct 10 while the control device 6 is toggled in the second state Likewise, the inlet bypass damper 12 is operatively integrated into the dual-purpose duct 1, wherein the inlet bypass damper 12 is used to hermetically seal the dual-purpose duct 1 or is used to allow air to flow through the dual-purpose duct 1. The inlet bypass damper 12 is positioned between the diverting duct 4 and the first bypass wye duct 17 in order to prevent the flow of air into the air-supply duct 2 while the control device 6 is toggled in the first state. The exhaust bypass damper 11 and the inlet bypass damper 12 are electronically coupled with the control device 6 in order for the exhaust bypass damper 11 and the inlet bypass damper 12 to be automatically manipulated between restricting and allowing the flow of air through the present invention, in accordance to which state the control device 6 is set by the user.

In accordance to the preferred embodiment of the present invention, the present invention comprises an air filter 13, as depicted in FIG. 1 to FIG. 5. The air filter 13 is mounted within the air-supply duct 2 and is positioned adjacent to the diverting duct 4, such that the flow of air is transferred through the air-supply duct 2 and into the structure, which the present invention is mounted, must pass through the air filter 13. The air filter 13 removes airborne particulates, such as pollen, dust, or mold, from the flow of air as it passes through the air filter 13.

Although the invention has been explained in relation to its preferred embodiment, it is to be understood that many other possible modifications and variations can be made without departing from the spirit and scope of the invention as hereinafter claimed.

What is claimed is:

1. A combination exhaust and supply duct comprises:
a dual-purpose duct;
an air-supply duct;
an exhaust duct;
a diverting duct;
an inline duct fan;
a control device;
the dual-purpose duct being adjacently connected to the diverting duct;
the air-supply duct being adjacently connected to the diverting duct, opposite to the dual-purpose duct;
the exhaust duct being adjacently connected to the diverting duct, opposite to the dual-purpose duct;
an inlet of the dual-purpose duct and the air-supply duct being in fluid communication with each other through the diverting duct;
an outlet of the dual-purpose duct and exhaust duct being in fluid communication with each other through the diverting duct;
the inline duct fan being in fluid communication with an outlet, through the dual-purpose duct; and
the inline duct fan being electronically coupled with the control device.

2. The combination exhaust and supply duct, as claimed in claim 1, comprises:
an exhaust fan;
the exhaust fan being in fluid communication with the outlet; and
the exhaust fan being electronically coupled with the control device.

3. The combination exhaust and supply duct, as claimed in claim 2, comprises:
the exhaust fan being mounted within the exhaust duct.

4. The combination exhaust and supply duct, as claimed in claim 2, comprises:
a diverting mechanism;
the exhaust fan being mounted within the diverting duct;
the exhaust fan being positioned adjacent to the exhaust duct;
the inline duct fan being mounted within the diverting duct;
the inline duct fan being positioned adjacent to the air-supply duct;
the diverting mechanism being operatively integrated within the diverting duct, wherein the diverting mechanism is used to direct the flow of air through either the air-supply duct or the exhaust duct; and
the diverting mechanism being electronically coupled with the control device.

5. The combination exhaust and supply duct, as claimed in claim 1, comprises:
the inline duct fan being mounted within the air-supply duct.

6. The combination exhaust and supply duct, as claimed in claim 5, comprises:
a fluid propagation direction of the inline duct fan being oriented away from the inlet of the dual-purpose duct.

7. The combination exhaust and supply duct, as claimed in claim 1, comprises:
the inline duct fan being mounted within the dual-purpose duct.

8. The combination exhaust and supply duct, as claimed in claim 7, comprises:
wherein the control device is toggled to a first state; and
a fluid propagation direction of the inline duct fan being oriented towards the outlet of the dual-purpose duct.

9. The combination exhaust and supply duct, as claimed in claim 7, comprises:
wherein the control device is toggled to a second state; and
a fluid propagation direction of the inline duct fan being oriented towards the inlet of the dual-purpose duct.

10. The combination exhaust and supply duct, as claimed in claim 1, comprises:
an inlet damper;
the inlet damper being electronically coupled with the control device;
the inlet damper being operatively integrated the air-supply duct, wherein the inlet damper is used to hermetically seal the air-supply duct or is used to allow fluid to flow through the air-supply duct; and
the inlet damper being positioned adjacent to the diverting duct.

11. The combination exhaust and supply duct, as claimed in claim 1, comprises:
an exhaust damper;
the exhaust damper being electronically coupled with the control device;
the exhaust damper being operatively integrated the exhaust duct, wherein the exhaust damper is used to hermetically seal the exhaust duct or is used to allow fluid to flow through the exhaust duct; and
the exhaust damper being positioned adjacent to the diverting duct.

12. The combination exhaust and supply duct, as claimed in claim 1, comprises:
the diverting duct comprises a three-way valve, a convergent duct, a first divergent duct, and a second divergent duct;
the three-way valve comprises a diverting mechanism, a valve inlet, a first valve outlet, and a second valve outlet;
the diverting mechanism being integrated between the valve inlet, the first valve outlet, the second valve outlet;
the convergent duct being hermetically coupled to the dual-purpose duct;
the first divergent duct being hermetically coupled with the air-supply duct;
the second divergent duct being hermetically coupled with the exhaust duct;
the convergent duct being hermetically coupled to the valve inlet;
the first divergent duct being hermetically coupled to the first valve outlet;
the second divergent duct being hermetically coupled to the second valve outlet; and
the diverting mechanism being electronically coupled with the control device.

13. The combination exhaust and supply duct, as claimed in claim 1, comprises:
an air-supply bypass duct;
a first bypass wye duct;
a second bypass wye duct;
the air-supply bypass duct comprises a first end and a second end;
the first bypass wye duct being mounted within the dual-purpose duct;
the second bypass wye duct being mounted within the air-supply duct;
the first end being hermetically coupled to the first bypass wye duct;
the first end being in fluid communication with the dual-purpose duct, through the first bypass wye duct;
the second end being hermetically coupled to the second bypass wye duct; and
the second end being in fluid communication with the air-supply duct, through the second bypass wye duct.

14. The combination exhaust and supply duct, as claimed in claim 13, comprises:
an inlet damper;
the inlet damper being operatively integrated into the air-supply duct, wherein the inlet damper is used to hermetically seal the air-supply duct or is used to allow air to flow through the air-supply duct; and
the inlet damper being positioned adjacent to the second bypass wye duct, opposite to the diverting duct.

15. The combination exhaust and supply duct, as claimed in claim 13, comprises:
an exhaust bypass damper;
an inlet bypass damper;
the exhaust bypass damper being operatively integrated into the air-supply bypass duct, wherein the exhaust bypass damper is used to hermetically seal the air-supply bypass duct or is used to allow air to flow through the air-supply bypass duct;
the exhaust bypass damper being positioned adjacent to the second bypass wye duct;
the inlet bypass damper being operatively integrated into the dual-purpose duct, wherein the inlet bypass damper is used to hermetically seal the dual-purpose duct or is used to allow air to flow through the dual-purpose duct;
the inlet bypass damper being positioned between the diverting duct and the first bypass wye duct; and
the exhaust bypass damper and the inlet bypass damper being electronically coupled with the control device.

16. The combination exhaust and supply duct, as claimed in claim 1, comprises:
an air filter;
the air filter being mounted within the air-supply duct; and
the air filter being positioned adjacent to the diverting duct.

17. The combination exhaust and supply duct, as claimed in claim 1, comprises:
the exhaust duct being positioned at an acute angle to the air-supply duct.
